(19) United States
(12) Patent Application Publication
(10) Pub. No.: US 2010/0100889 A1
(43) Pub. Date: Apr. 22, 2010

(54) ACCELERATING MUTUAL EXCLUSION LOCKING FUNCTION AND CONDITION SIGNALING WHILE MAINTAINING PRIORITY WAIT QUEUES

(75) Inventors: ROBERT G. LABRIE, TUCSON, AZ (US); JAMES J. MYERS, PARADISE, CA (US)

Correspondence Address: PATENTS ON DEMAND, P.A.-IBM ACCSPP, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/252,938

(22) Filed: Oct. 16, 2008

(51) Int. Cl. G06F 9/52

(52) U.S. Cl. 718/106

(57) ABSTRACT

A synchronization library of mutex functions and condition variable functions for threads which are compatible with pthread library functions conforming to a (POSIX) standard. The library can utilize a mutex data structure and a condition variable data structure both including lockwords and queuing anchors. In the library, Compare Swap (CS) instruction processing can be used to protect shared resource. The synchronization library can support priority queuing of threads and can have an ability to yield control when CS spin lock iterations exceed a set limit.

### BACKGROUND

The present invention relates to the field of thread synchronization and, more particularly, to accelerating mutual exclusion locking function and condition signaling while maintaining priority wait queues.

Software executing on multi-threaded operating systems (OS), such as Z/OS, often protect shared resources using mutual exclusion (mutex) locking. The mutual exclusion locking can maintain serialization on shared resources.

This locking can be performed using a set of available library functions, such as the pthread_mutex_lock and pthread_mutex_unlock function of a POSIX library. Library functions, such as the pthread ones, can suspend a calling thread when a resource is acquired by another thread. The pthread_mutex_lock and unlock library functions are CPU intensive and when used frequently by an application can consume a significant amount CPU processing power allocated to an application. Further, pthread_mutex_lock and unlock library functions lack an ability to recognize application specific priority threads. This lack of priority thread awareness results in higher priority threads being queued behind lower priority threads during pthread_mutex_lock wait queuing. Thus, the pthread_mutex_lock and unlock functions do not always support situations in a satisfactory way where the application requires priority threads to effectively preempt normal threads waiting for the same resource.

Known work a-rounds to the problems of the pthread library exist, yet all have significant shortcomings. For example, a Z/OS application programmer can use SYSZTIOT enq methods for serialization. This, however, forces all threads to share a single resource when many unique mutex operations are processing simultaneously, which results in a bottleneck due to the fact that a single SYSZTIOT exists per z/OS address space.

In another example, the Compare Swap instruction is available to maintain serialization on a lockword. When used by itself, however, it can result in lengthy spin loop processing that is likely to use more CPU resources than pthread mutex locking functions.

At present, applications executing on Z/OS that make frequent use of mutex_lock and mutex_unlock calls are penalized by inefficiencies present in current implementations of a C runtime library for z/OS. Similar limitations exist for pthread library functions used for condition signaling.

### BRIEF DESCRIPTION OF THE SEVERAL VIEWS OF THE DRAWINGS

FIG. 1 is a schematic diagram of a system that includes a FastMutex library that enhances functions of a standard pthread library in accordance with an embodiment of the inventive arrangements disclosed herein.

FIG. 2A provides sample code for a mutex structure and a spin lock function.

FIG. 2B provides sample code for determining mutex availability and for maintaining queue waiting threads.

FIG. 3A illustrates a flow chart of using compare swap to serialize on a lockword.

FIG. 3B illustrates a flow chart of determining mutex availability and placing threads in a waiting queue based upon thread priority status.

FIG. 3C illustrates a flow chart of a thread suspending itself upon being added to a wait queue for a mutex.

FIG. 3D illustrates a flow chart of suspending a thread assuming ownership of a released mutex.

FIG. 3E illustrates a flow chart of a process for checking a wait queue to assign ownership of a released mutex in accordance with the wait queue.

FIG. 3F illustrates a flow chart of the wait condition for a condition variable.

FIG. 3G illustrates a flow chart of the signal condition for a condition variable.

FIG. 3H illustrates a flow chart of a broadcast condition for a condition variable.

FIG. 4A shows a set of charts for a sample performance test between the FastMutex library and the pthread library functions.

FIG. 4B shows a set of tables for a sample performance test between the FastMutex library and the pthread library functions.

FIG. 5 illustrates a sample chain of waiting threads.

### DETAILED DESCRIPTION

This disclosure describes a FastMutex library superior to and compatible with a standard pthread library. The disclosed FastMutex library accelerates mutual exclusion locking and condition signaling compared to standard mutex and condition functions in the pthread library. Speed gains are achieved through highly efficient compare swap (CS) instruction processing. Further, the FastMutex library adds a technique to establish and recognize priority threads and to assure that priority threads are handled in a wait queue before threads having a normal priority level. Additionally, the FastMutex library is able to yield control when CS spin lock iterations exceed a previously configured threshold.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer usable or computer-readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

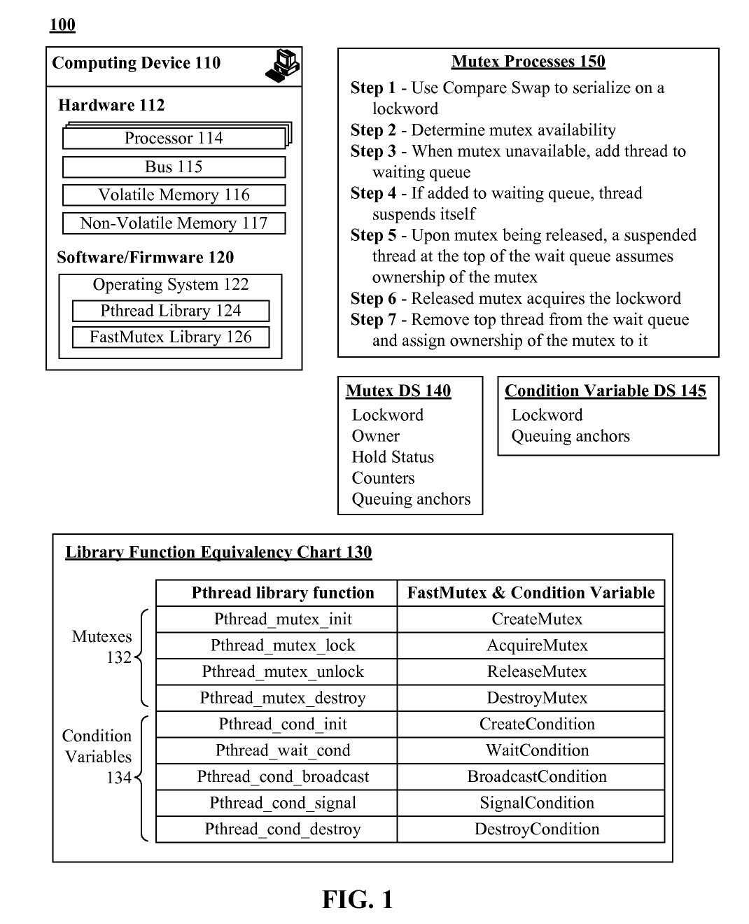

FIG. 1 is a schematic diagram of a system 100 that includes a FastMutex library 126 that enhances functions of a standard pthread library 124 in accordance with an embodiment of the inventive arrangements disclosed herein. Library 124, 126 functions can be called using operating system 122 commands. The operating system 122 can be included in software/firmware 120 of a computing device 110. The libraries 124, 126 and operating system 122 can be stored in a storage medium, such as memory 116 or 117. Hardware 112 of the device 110 can include one or more processors 114 connected to a volatile memory 116 and a non-volatile memory 117 via bus 115. The processor(s) 114, each of which may have one or more cores, can handle threads in accordance with the libraries 124, 126.

The pthread library 124 is a function library conforming to a Portable Operating System Interface (POSIX) standard for handling threads. The POSIX standard defines an application program interface (API) for creating and manipulating threads. The FastMutex library 126 provides a set of replacement functions for those functions of the pthread library 124 that provide synchronization functions for mutexes 132 and condition variables 134. Thread manipulation functions (e.g., pthread_create, pthread_exit, pthread_cancel, pthread_join, pthread_attr_init, pthread_attr_setdetachstate, pthread_attr_getdetachstate, pthread_attr_destroy, pthread_kill, etc.), thread local storage functions (e.g., pthread_key_create, pthread_setspecific, pthread_getspecific, pthread_key_delete, etc.), and utility functions (e.g., pthread_equal, pthread_detach, pthread_self, etc.) can operate normally with replacement FastMutex library 126 functions without modification.

For example, in one embodiment, a POSIX application can still use pthread_create to create a thread. The pthread_create function attaches an MVS TCB to the created thread in the address space. The application can support two types of thread, normal and priority. Because a POSIX thread maps to an MVS TCB, the FastMutex library 126 can use an MVS WAIT macro to suspend a thread waiting for a mutex or condition variable. Additionally, the MVS POST macro can be used to schedule threads when mutex ownership is passed to a waiting thread or when a condition is signaled.

Chart 130 shows a set of pthread library 124 functions and their equivalent FastMutex library 124 functions. More specifically, pthread_mutex_init can be replaced with CreateMutex; pthread_mutex_lock with AcquireMutex; pthread_mutex_unlock with ReleaseMutex; pthread_mutex_destroy with DestroyMutex; pthread_cond_init with CreateCondition; pthread_wait_cond with WaitCondition; pthread_cond_broadcast with BroadcastCondition; pthread_cond_signal with SignalCondition; and pthread_cond_destroy with DestroyCondition.

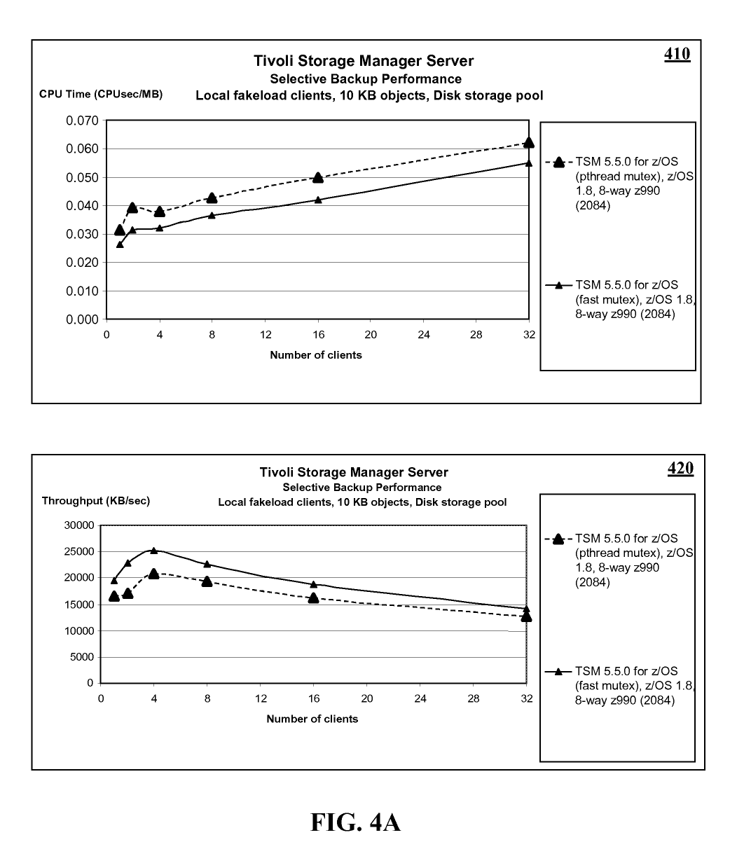

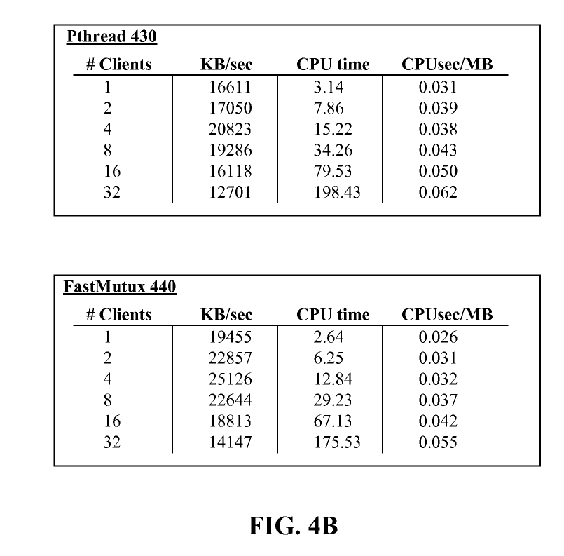

Use of a Compare Swap (CS) instruction processing in the FastMutex library 126 results in a highly efficient method to protect a shared resource. A sample performance test between the FastMutex library 126 and the pthread library 124 functions is shown in FIGS. 4A and 4B. Although the test was conducted using TIVOLI STORAGE MANAGER for z/OS Program Product version 5.5, implementations are not limited to any particular system or to the configuration specifics used for the performance test.

More specifically, chart 410 compares pthread mutex functions versus FastMutex functions (functions 132). Chart 420 compares pthread condition variables versus FastMutex condition variables (functions 134). In the charts 410, 420, slopes labeled pthread mutex indicate mutex and condition variable activity using the pthread library functions. Slopes labeled FastMutex use application code of the FastMutex functions. CPU time was collected from SDSF job summary of CPU seconds used for that instance of the application for each test run. The throughput in KB/second was collected from a TIVOLI STORAGE MANAGER client API program. Results were repeated for each test. The test was performed using a single client connection where the session moved 10,000 10 KB size files to the server. The test was repeated to demonstrate scalability with two, four, eight, sixteen, then thirty-two client instances, each of which moved 10,000 10 KB size files to the TIVOLI STORAGE MANAGER server. The pthread table 430 and FastMutex table 440 display test results, which show performance gains achieved using the FastMutex functions.

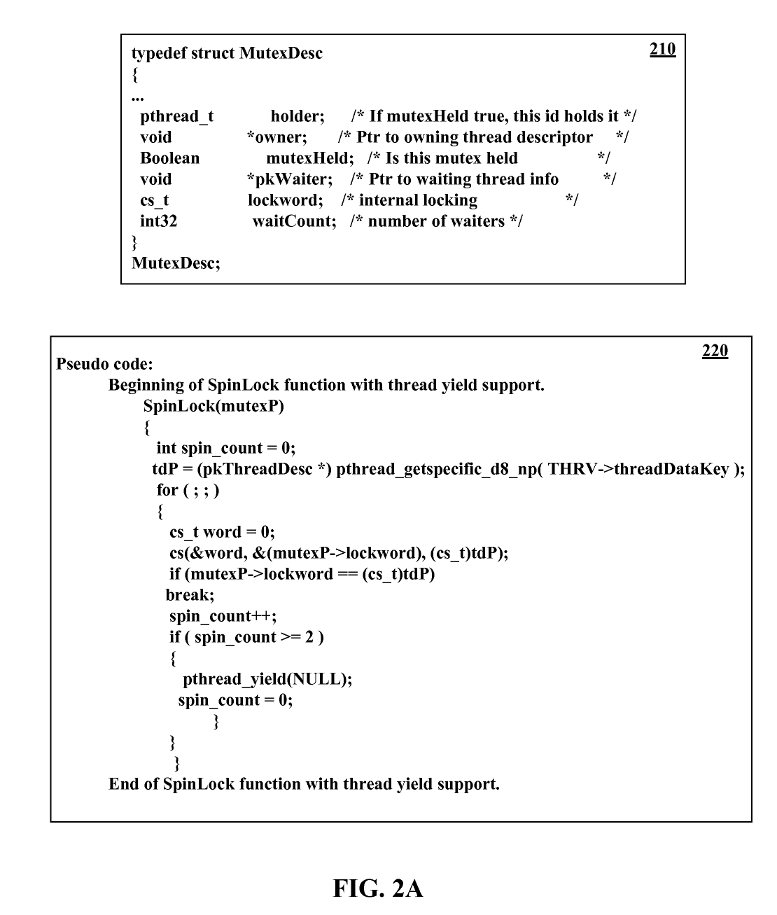

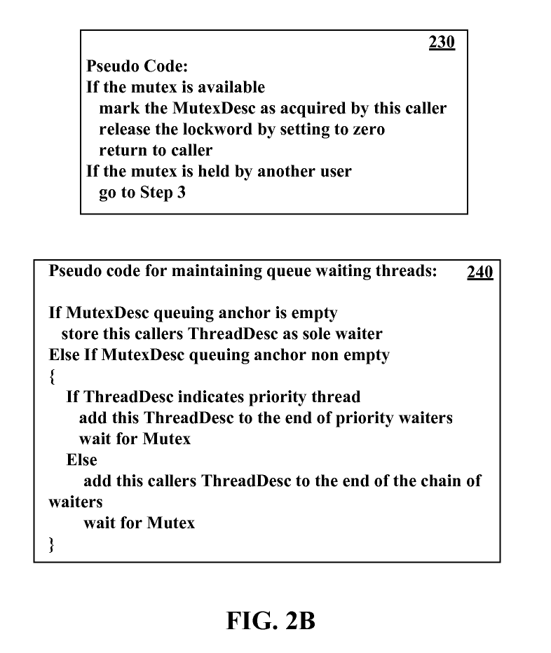

A data structure 140 for a mutex used by the FastMutex library 126 can include several fields, such as a lockword for serialization, an owner, a hold status, counters, and queuing anchors. Library 126 functions can be created that each use this data structure 140. For example, the CreateMutex function can allocate, clear, and initialize fields of the mutex data structure 140. One embodiment for data structure 140 is shown in code sample 210 of FIG. 2.

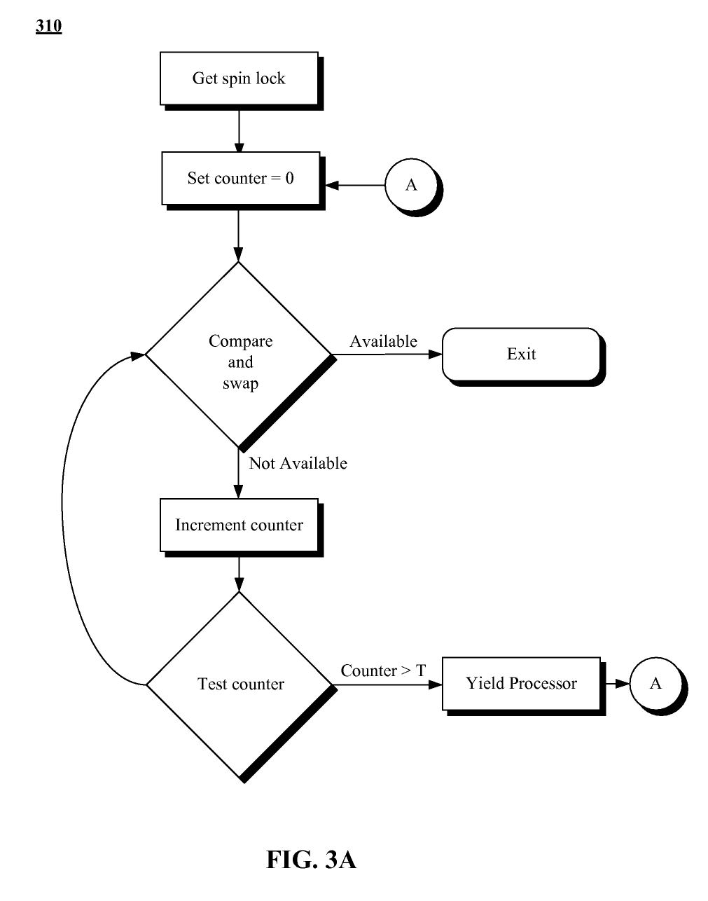

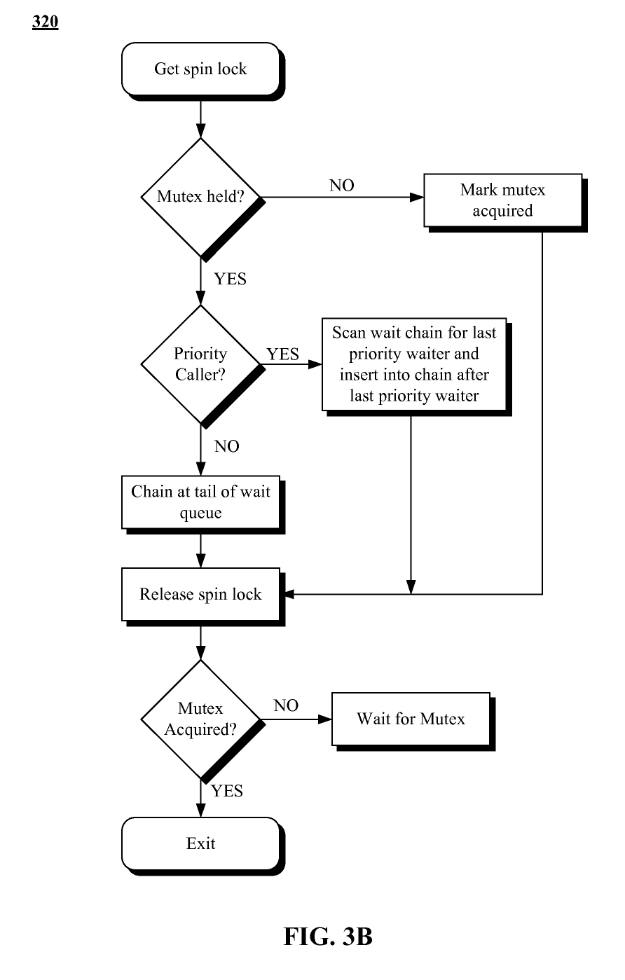

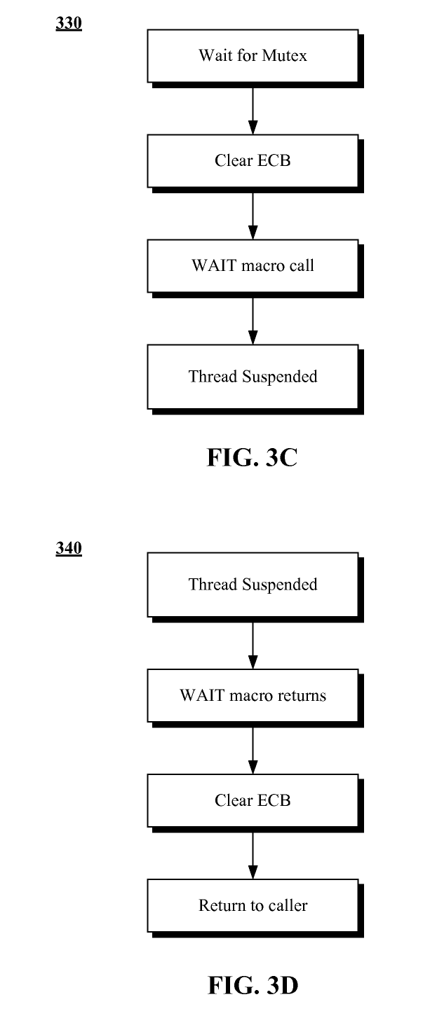

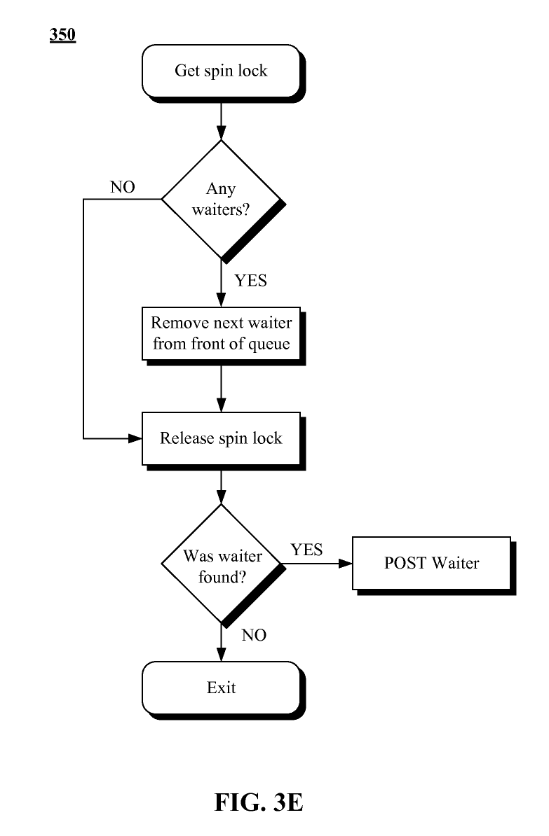

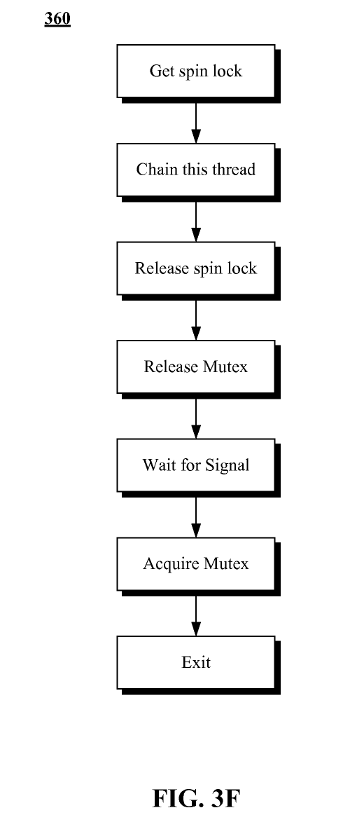

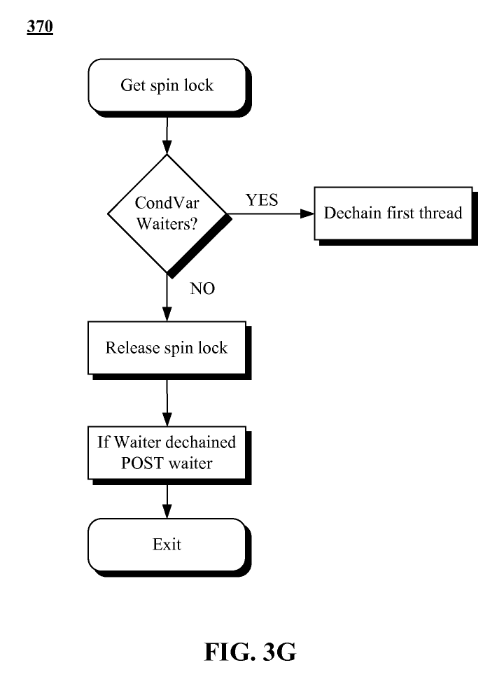

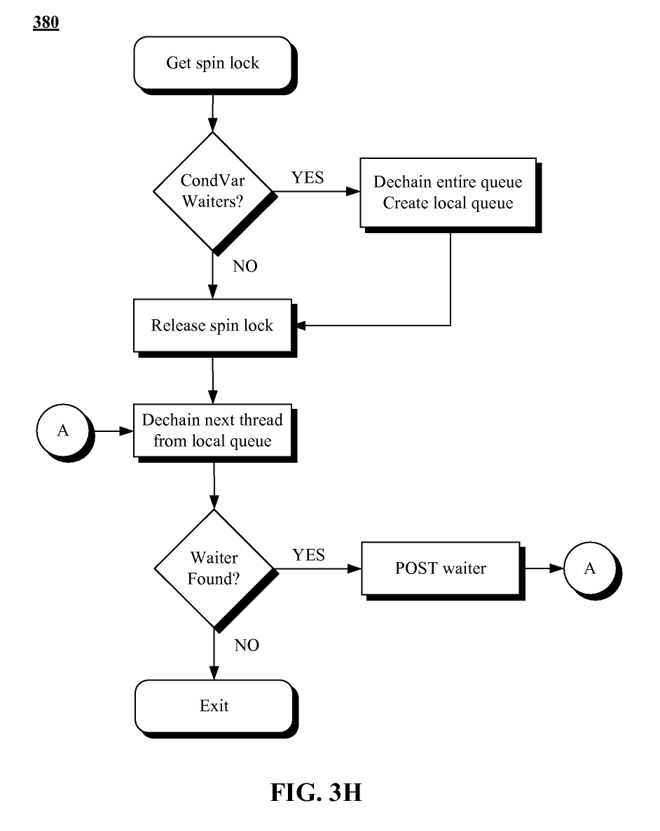

When an application wishes to acquire a mutex 150 instead of calling the standard pthread_mutex_lock function, the AcquireMutex function can be called. The AcquireMutex routine will attempt to serialize access to the mutex data structure control block using a Compare Swap (CS) instruction, as indicated by Step 1 of mutex processes 150. Flow chart 310 shown in FIG. 3A elaborates upon this step.

In flow chart 310, a spin lock can be acquired and a counter can be initialized to zero. A compare and swap operation can be performed to determine mutex availability. When available, the process can end. When not available, the counter can be incremented. The counter can then be tested against a threshold, which causes the processor to be yielded when the threshold is exceeded. This yielding avoids lengthy spin lock conditions while waiting for a mutex. When the counter is less than the threshold, a Compare and Swap operation can again be performed to check for mutex availability. Compare and Swap logic for flow chart 310 is further detailed by sample code 220 of FIG. 2A.

A lockword of a mutex data structure 140 instance is owned by a caller. When owned (unavailable), other threads are prevented from updating the mutex. Step 2 utilizes the fields of a mutex data structure 140 to determine whether or not a mutex is available. If so, the mutex is marked as being acquired by the caller and the lockword is released before returning to the caller. If the mutex is held by another user, processing can progress to Step 3 of the processes 150. Pseudo code 230 of FIG. 2B describes afore mentioned actions to be taken in Step 2.

A precondition for Step 3 of process 150 is that one or more thread is to be placed or is currently residing in a waiting queue, since a desired mutex is initially owned by another thread. In Step 3, a lockword of the mutex remains intact and is held by another calling thread. The lockword protects the mutex from updates by other threads. The mutex data structure 140 provides a place to anchor a chain of waiting threads. The calling thread can be chained (or queued) using an application ThreadDesc control block specific to the caller's thread.

Pseudo code sample 240 of FIG. 2B shows sample code for adding a new thread to a waiting queue. As shown in code 240, if a mutex queuing anchor is empty, the thread is stored as a sole waiting thread. Otherwise, a check to see if the thread has a priority status is made. If it has the priority status, the new waiting thread is added at the end of a set of waiting threads having priority, which places it before all waiting threads not having priority. If the added thread does not have priority status, it is added to the end of the set of waiting threads. Flow chart 320 of FIG. 3B describes a combination of Step 2 and Step 3 in more detail.

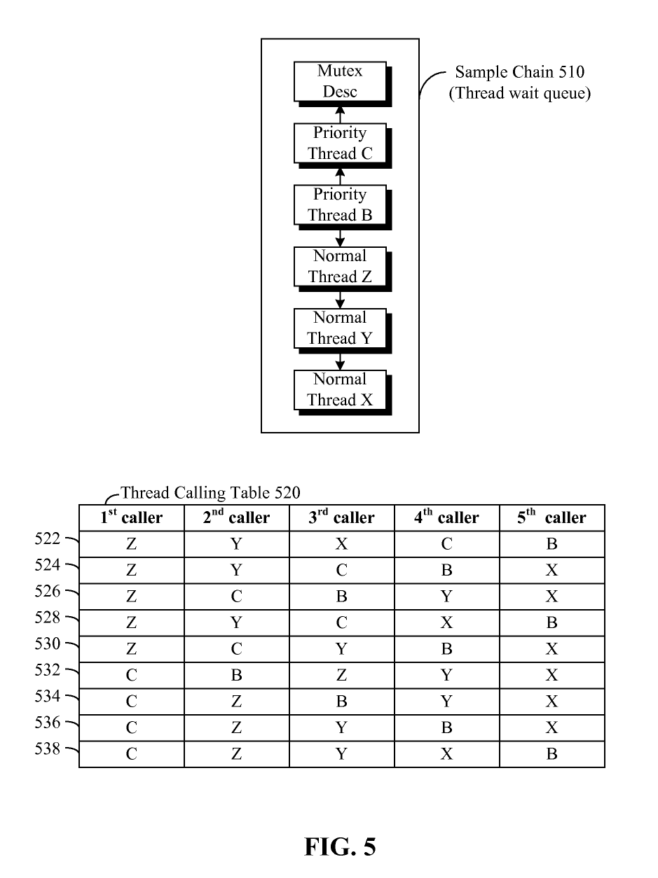

Additionally, FIG. 5 illustrates a sample chain 510 of waiting threads. The chain 510 includes five threads, Thread B, Thread C, Thread X, Thread Y, and Thread Z, where Threads B and C have a priority status and threads X, Y, and Z have a normal priority level. The sample chain 510 can result from the Threads B, C, X, Y, and Z being called in any of the calling orders 522-538 shown in table 520. Each calling instance is performed using the AcquireMutex function.

In calling order 522, normal Threads Z, Y, and X are called in order and added to the chain 510 in the order in which they are called (FIFO). Then, Thread C is called, which is a priority thread, so it is added to the top of the chain 510. Finally, Thread B is called, which is a priority thread, so it is added to the chain 510 after Thread C (which also has priority) but before Thread Z (which does not have priority).

Equivalent results (shown by chain 510) result from any of the other orders 524-538. For example, in calling order 530, Thread Z is first placed in the chain 510, but a next called Thread C is placed above it, since thread C has priority over thread Z. A third Thread Y does not have priority, so it is placed at the bottom of the chain 510 (after Thread Z). A fourth called Thread B has priority so it is placed in the chain 510 under Priority Thread C, but before normal Thread Z. Finally, Thread X is called and added to the bottom of the chain 510 of waiting threads.

In Step 4 of processes 150, a calling thread can suspend itself Flow chart 330 of FIG. 3C provides details on how the suspension occurs. A calling thread should first wait for the mutex, which causes it to be queued (as described in Step 3). Each queued thread can have its own ECB, which it clears. The thread can suspend itself using MVS WAIT macro.

In Step 5 of processes 150, a previously suspended thread (on top of the wait queue) can assume ownership of a mutex, once it is released. Flow chart 340 of FIG. 3D provides details specific to Step 5.

In Step 6 of processes 150, a released mutex can acquire a lockword using a spin lock (as shown by code 220). After acquiring exclusive access of a mutex, a chain of waiting threads can be safely examined. If no waiting threads are included in the chain, the spin lock can be released and the mutex can be marked as available and returned to the caller. If one or more threads are waiting in the chain of queued threads, Step 7 can occur.

In Step 7, a topmost thread can be removed from the wait queue and ownership of the mutex can be assigned to it. This amounts to marking the ownership field of the mutex (140) with the newly removed thread. The waiting thread, just removed from the queue, can be scheduled for executing using the MVS POST macro. Steps 6 and 7 are illustrated in FIG. 3E as flow chart 350.

Conditional variables 134 of the FastMutex library 126 can be implemented similar to the mutexes 132. A condition variable data structure 145 is allocated memory such as the mutex data structure 140. The condition variable data structure 145 also contains a field for a lockword and queuing anchors for waiting threads. Condition variable wait queues do not recognize priority threads and therefore always queue waiting threads in FIFO order.

Just as the pthread_cond_wait function requires a mutex, the WaitCondition call requires a mutex as well. Then the condition variable lockword is acquired using the same logic outlined for acquiring a mutex lockword. The lockword, in this case however, is located in the condition variable data structure 145.

Once the condition variable lockword is acquired, the calling thread unconditionally queues itself on the chain of threads waiting for a signal. The spin lock is then released. A thread in the condition variable wait queue can suspend itself by calling MVS WAIT macro. When the condition variable is signaled by another thread, the thread waiting for the signal can receive control from the MVS WAIT macro call. This thread can then reacquire the mutex before returning to the caller. Flow chart 360 of FIG. 3F illustrates the wait condition for a condition variable. Flow chart 370 of FIG. 3G illustrates the signal condition for a condition variable. Flow chart 380 of FIG. 3H illustrates a broadcast condition for a condition variable.

The flowchart and block diagrams in the FIGS. 1-5 illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A software library comprising:
a synchronization library of functions for threads which are compatible with pthread library functions conforming to a Portable Operating System Interface (POSIX) standard excepting the pthread synchronization library functions, where the synchronization library functions are configured to be used in place of existing pthread synchronization library functions, wherein said synchronization library functions comprise mutex functions and condition variable functions;
a mutex data structure configured to be used with the mutex functions of the synchronization library, wherein the mutex data structure comprises fields for a lockword, for an owner, and queuing anchors for threads waiting to acquire an instance of the mutex data structure;
a condition variable data structure configured to be used with the condition variable functions of the synchronization library, wherein the condition variable data structure comprises fields for a lockword and for queuing anchors for threads waiting to acquire an instance of the condition variable data structure, wherein the synchronization library is stored in a storage medium, and wherein the synchronization library is configured to utilize Compare Swap (CS) instruction processing to protect shared resources, wherein the Compare Swap (CS) instruction processing operates against a lockword of a mutex data structure instance and a lockword of a condition variable data structure instance.

2. The software library of claim 1, wherein the synchronization library permits pthread to possess at least two priority states, wherein the synchronization library is configured such that when threads are added to a queue of threads waiting on a mutex data structure instance, threads associated with a greater priority state are placed in the queue above pre-existing threads associated with a lesser priority state, wherein the synchronization library is configured such that threads placed in the queue having equivalent priority states are processed in a first-in-first-out (FIFO) manner.

3. The software library of claim 1, wherein the synchronization library is configured such that spin locked threads yield control while waiting for a mutex data structure instance when a number of cycles waited exceeds a configurable and previously established threshold.
